(19) United States
(12) Patent Application Publication
(10) Pub. No.: US 2024/0038519 A1
(43) Pub. Date: Feb. 1, 2024

(54) MULTIPOLE SECTION-BASED ION FUNNEL

(71) Applicant: AGILENT TECHNOLOGIES, INC., Santa Clara, CA (US)

(72) Inventors: Kenneth R. NEWTON, Santa Clara, CA (US); Tong CHEN, Santa Clara, CA (US); Stephen ZANON, Santa Clara, CA (US)

(73) Assignee: AGILENT TECHNOLOGIES, INC., Santa Clara, CA (US)

(21) Appl. No.: 18/345,595

(22) Filed: Jun. 30, 2023

Related U.S. Application Data
(60) Provisional application No. 63/393,459, filed on Jul. 29, 2022.

(51) Int. Cl. H01J 49/06

(52) U.S. Cl. CPC H01J 49/066; H01J 49/063

(57) ABSTRACT

In some examples, a multipole section-based ion funnel may include an ion funnel section formed by at least one pair of adjacently disposed members. A first member of the at least one pair of adjacently disposed members may include a pole structure. A second member of the at least one pair of adjacently disposed members may include a pole structure that is engageable with the pole structure of the first member to form a multipole structure.

### PRIORITY

This application claims priority to commonly assigned and co-pending Provisional Application Ser. No. 63/393,459, filed Jul. 29, 2022, titled “MULTIPOLE SECTION-BASED ION FUNNEL”, the disclosure of which is hereby incorporated by reference in its entirety.

### BACKGROUND

An ion funnel may be a device that is used within a mass spectrometer system to collect ions. In one example, the ion funnel may include a relatively large entrance diameter and transport ions to an exit with a relatively small exit diameter. In one type of ion funnel, a set of stacked (e.g., parallel) plates may include an opening in each plate, and the openings may be aligned along a central axis.

During operation of the mass spectrometer system, ions may enter through the relatively large diameter entrance and exit through the relatively small diameter exit. The ions may be moved forward from the entrance to the exit by means of an axial electric field. The axial electric field may be created by setting direct current (DC) potentials of each plate to form a downhill potential drop from entrance to exit. Ions may be prevented from striking walls of the ion funnel, for example, at a ring diameter or at each plate, by applying alternate phase radio frequency (RF) voltage to the plates. In one example, the RF and DC voltages may be distributed to the set of plates with a resistor and capacitor ladder from a pair of RF inputs and a pair of DC inputs.

In some cases, ions may be cooled within the ion funnel by colliding with a background gas such as nitrogen. The background gas may assist in gathering ions with relatively large input energies to deliver ions at the exit with a relatively low energy.

### BRIEF DESCRIPTION OF DRAWINGS

Features of the present disclosure are illustrated by way of example and not limited in the following figure(s), in which like numerals indicate like elements, in which:

FIG. 1A illustrates an isometric cutout view of a multipole section-based ion funnel, illustrating interior features of the multipole section-based ion funnel, in accordance with an example of the present disclosure;

FIGS. 1B and 1C illustrate side and front views, respectively, of the multipole section-based ion funnel of FIG. 1A, in accordance with an example of the present disclosure;

FIG. 2A illustrates an enlarged isometric cutout view of an exit of the multipole section-based ion funnel of FIG. 1A, in accordance with an example of the present disclosure;

FIG. 2B illustrates an enlarged side cutout view of an exit of the multipole section-based ion funnel of FIG. 1A, in accordance with an example of the present disclosure;

FIG. 3 illustrates an enlarged isometric view of a pair of adjacently disposed members of the multipole section-based ion funnel of FIG. 1A, in accordance with an example of the present disclosure;

FIG. 4 illustrates an enlarged cutout side view of an exit of the multipole section-based ion funnel of FIG. 1A, in accordance with an example of the present disclosure;

FIG. 5 illustrates an enlarged cutout front view of the exit of FIG. 4, viewing the exit from inside of the multipole section-based ion funnel of FIG. 1A, illustrating various examples of pole structures, in accordance with an example of the present disclosure;

FIG. 6 illustrates an enlarged isometric view of another example of a member of the multipole section-based ion funnel of FIG. 1A, in accordance with an example of the present disclosure;

FIG. 7 illustrates an enlarged isometric diagrammatic view of a hexagonal layout of pole structures, in accordance with an example of the present disclosure;

FIG. 8 illustrates an enlarged side diagrammatic view of the hexagonal layout of the pole structures of FIG. 7, in accordance with an example of the present disclosure;

FIG. 9 illustrates an enlarged isometric diagrammatic view of another hexagonal layout of pole structures, in accordance with an example of the present disclosure;

FIG. 10 illustrates an enlarged side diagrammatic view of the hexagonal layout of the pole structures of FIG. 9, in accordance with an example of the present disclosure;

FIG. 11 illustrates radio-frequency (RF) field distribution for different types of configurations of the multipole section-based ion funnel of FIG. 1A, in accordance with an example of the present disclosure;

FIGS. 12A, 12B, and 12C illustrate different types of exits and flight paths for ions in the multipole section-based ion funnel of FIG. 1A, in accordance with an example of the present disclosure;

FIG. 13 illustrates various views of a multipole section-based ion funnel including a plurality of exits, in accordance with an example of the present disclosure;

FIG. 14 illustrates examples of exit or internal configurations for the multipole section-based ion funnel of FIG. 1A, in accordance with an example of the present disclosure; and

FIG. 15 illustrates examples of implementation of the internal configurations of FIG. 14 for the multipole section-based ion funnel of FIG. 1A, in accordance with an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, and the term “including” means including but not limited to. The term “based on” means based at least in part on.

With respect to ion funnels, as disclosed herein, in some cases ions may be cooled within an ion funnel by colliding with a background gas such as nitrogen. The background gas may assist in gathering ions with relatively large input energies to deliver ions at an exit with a relatively low energy. Generally, a gas pressure for the background gas may include a range of approximately 1 to 10 Torr. In this regard, it is technically challenging to further reduce the gas pressure and/or a diameter of an exit of the ion funnel without negatively impacting operation of the ion funnel. The gas pressure may be reduced to much lower levels if attention is given to the RF operating frequency, amplitude and funnel geometry and the desired operating mass range.

With respect to ion funnel plates, an alternating RF phase between adjacent ion funnel plates may create a localized electric field near an inside diameter of openings in the plates. Depending on ion mass, the effect of this localized field may extend to different distances from the associated electrodes, with low mass ions being maintained at a larger distance from the electrodes. As the diameter adjacent to the exit of the ion funnel decreases, the low mass ions may experience fields that overlap from both sides of the ion funnel. These overlapping fields may become a barrier for transport of low mass ions. These low mass ions may either take longer to exit the ion funnel due to being slowed down, or may become trapped near the ion funnel exit for extended periods of times. These factors may indicate that for a given set of operating voltages, there is a low ion mass limit for the ion funnel to transport ions out of the exit. Although it may be possible to reduce the low ion mass limit by reducing the RF amplitude or increasing an associated frequency, these factors may also negatively affect the transmission of other ion masses.

In one example, flat ion funnel plates may be utilized in parts of the ion funnel where ion stalling or trapping does not occur for any ion mass. In this regard, it is technically challenging to utilize the flat ion funnel plates for an ion funnel diameter that is smaller than a value that would cause stalling.

In order to address at least the aforementioned technical challenges, the plates of an ion funnel may be replaced with one or more pairs of adjacently disposed members that form a multipole structure as disclosed herein. Examples of multipole structures may include quadrupole, hexapole, octopole, 10-pole, etc. Each pair of the adjacently disposed members may also be denoted as an RF multipole segment. Each pair of the adjacently disposed members may be mounted within the overall ion funnel structure, and may utilize the same circuit elements to distribute the RF and DC potentials from the same inputs.

In one example of implementation of one or more pairs of the adjacently disposed members, a multipole section-based ion funnel may include an ion funnel section formed by at least one pair of adjacently disposed members. A first member of the at least one pair of adjacently disposed members may include a pole structure. Further, a second member of the at least one pair of adjacently disposed members may include a pole structure that is engageable with the pole structure of the first member to form a multipole structure.

According to examples disclosed herein, the pole structure of the first member and the pole structure of the second member may form at least two poles. The at least two poles may be symmetrically disposed along a circumference of a circular opening formed by the at least one pair of adjacently disposed members. Alternatively, the at least two poles may be disposed along a boundary of a non-circular opening formed by the at least one pair of adjacently disposed members.

According to examples disclosed herein, RF field distribution areas at the at least two poles may be greater than RF field distribution areas at another ion funnel section of the multipole section-based ion funnel that does not include the at least one pair of adjacently disposed members.

According to examples disclosed herein, the pole structure of the first member and/or the pole structure of the second member may include a concave, a convex, a generally flat, and/or a round profile.

According to examples disclosed herein, the at least one pair of adjacently disposed members may form an electrode pair that may include at least two poles and are of opposite polarities.

According to examples disclosed herein, the ion funnel section formed by the at least one pair of adjacently disposed members may be tapered or profiled to form a reduced diameter exit for ions traversing through the multipole section-based ion funnel. For example, the exit may be disposed along a central axis of the multipole section-based ion funnel. Alternatively, the exit may be radially offset relative to a central axis of the multipole section-based ion funnel.

According to examples disclosed herein, the ion funnel section formed by the at least one pair of adjacently disposed members may include a linear funnel progression from a dipole structure to the multipole structure that includes greater than two poles.

According to examples disclosed herein, the ion funnel section formed by the at least one pair of adjacently disposed members may be tapered or profiled to form a plurality of reduced diameter exits for ions traversing through the multipole section-based ion funnel. The reduced diameter exits may be of the same or different sizes to allow, for example, ions of different sizes to traverse through different sized exits of the multipole section-based ion funnel.

According to examples disclosed herein, the ion funnel section may include a plurality of further members. Each member of the plurality of further members may include an opening that is offset from a central axis of the multipole section-based ion funnel. Further, the plurality of further members may form a non-direct flight path for ions traversing through the multipole section-based ion funnel.

According to examples disclosed herein, the multipole structure may permit operation of the multipole section-based ion funnel for a pressure range of approximately 1 mTorr to approximately 10 Torr. The multipole structure may thus enable a larger mass range and/or a smaller exit beam diameter.

According to examples disclosed herein, the first member and/or the second member of the at least one pair of adjacently disposed members may be at least partially formed as a plate.

In another example of implementation of one or more pairs of the adjacently disposed members, a multipole structure may include a first member of a pair of members, where the first member includes a pole structure, and a second member of the pair of members. The second member may include a pole structure that is engageable with the pole structure of the first member to form the multipole structure for a multipole section-based ion funnel.

According to examples disclosed herein, the pole structure of the first member and/or the pole structure of the second member may be transverse relative to a central axis of the multipole section-based ion funnel.

In a further example of implementation of one or more pairs of the adjacently disposed members, a multipole section-based ion funnel may include a tapered ion funnel section formed by a plurality of pairs of adjacently disposed members. A first member of a pair of members of the plurality of pairs of adjacently disposed members may include a pole structure. A second member of the pair of members of the plurality of pairs of adjacently disposed members may include a pole structure that is engageable with the pole structure of the first member to form a multipole structure. Further, at least two pairs of the plurality of pairs of the adjacently disposed members may include successively reduced diameter openings.

According to examples disclosed herein, a first pair of the plurality of pairs of the adjacently disposed members may include a specified number of poles that is greater than a specified number of poles for a second pair of the plurality of pairs of the adjacently disposed members.

According to examples disclosed herein, the second pair of the plurality of pairs of the adjacently disposed members may be disposed closer to an exit of the multipole section-based ion funnel compared to the first pair of the plurality of pairs of the adjacently disposed members. Alternatively, the second pair of the plurality of pairs of the adjacently disposed members may be disposed closer to an entrance of the multipole section-based ion funnel compared to the first pair of the plurality of pairs of the adjacently disposed members.

According to examples disclosed herein, a first pair of the plurality of pairs of the adjacently disposed members and a second pair of the plurality of pairs of the adjacently disposed members may include an equal number of poles.

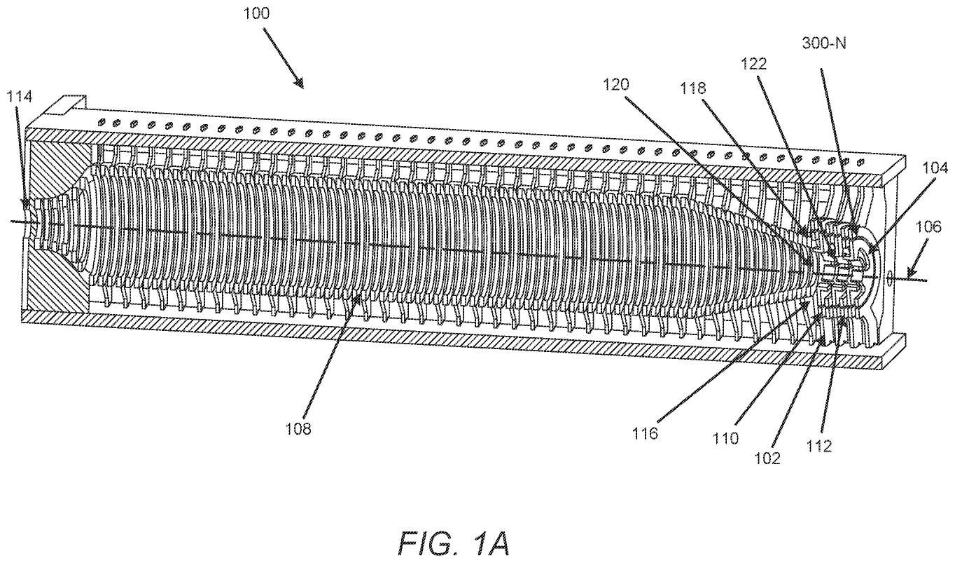

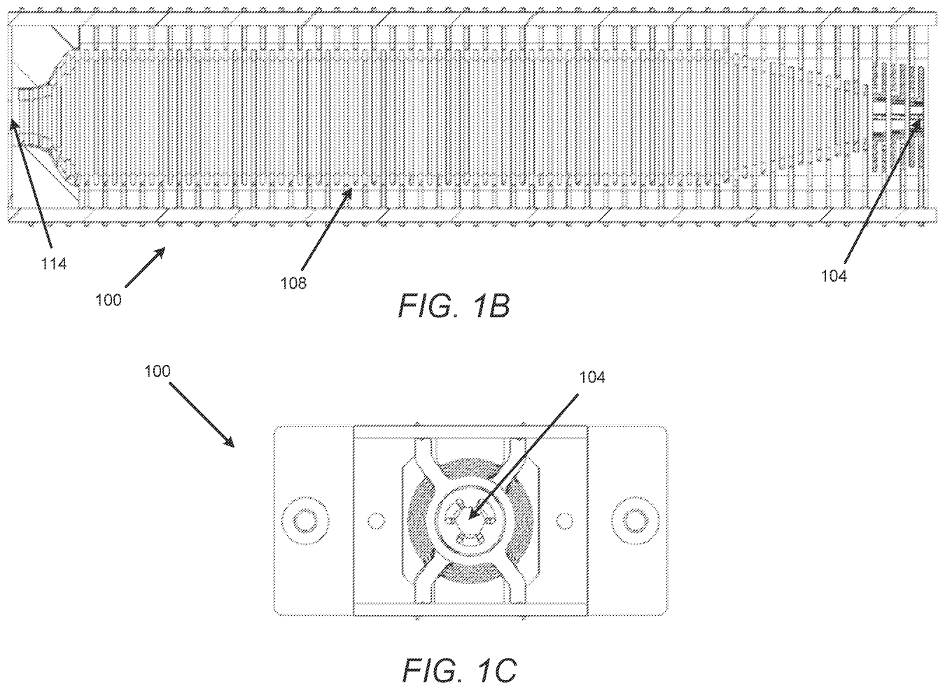

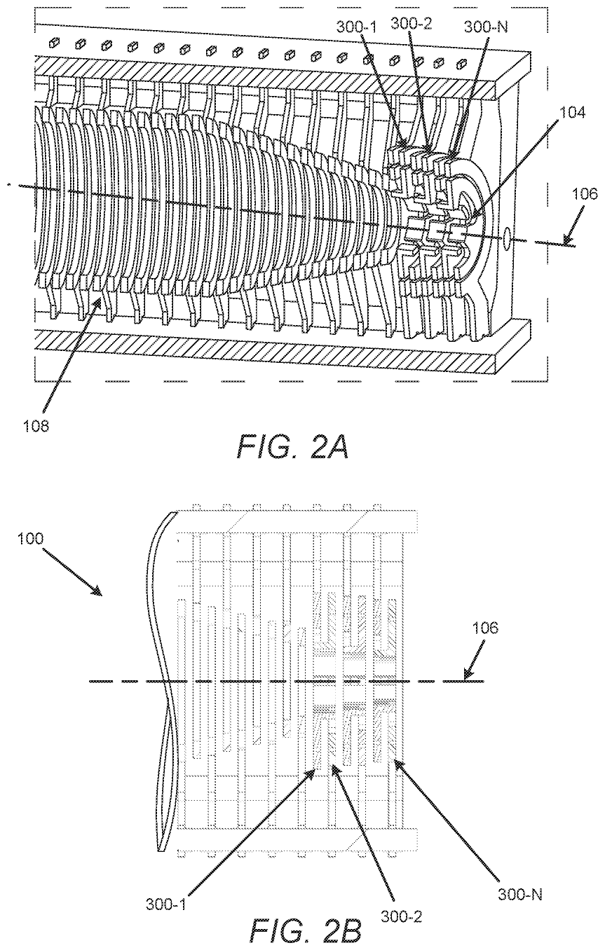

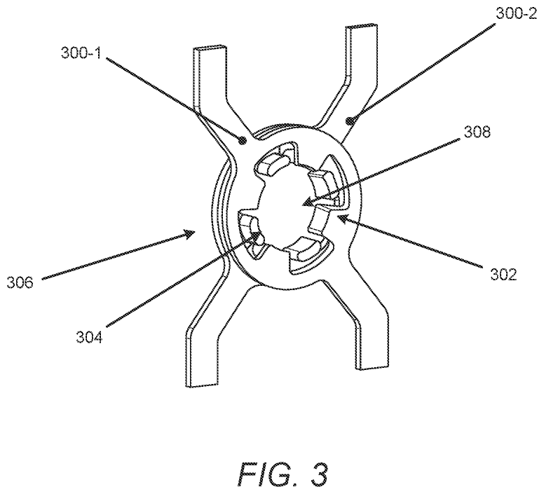

FIG. 1A illustrates an isometric cutout view of a multipole section-based ion funnel 100, illustrating interior features of the multipole section-based ion funnel 100, in accordance with an example of the present disclosure. FIGS. 1B and 1C illustrate side and front views, respectively, of the multipole section-based ion funnel 100, in accordance with an example of the present disclosure. FIG. 2A illustrates an enlarged isometric cutout view of an exit of the multipole section-based ion funnel 100, in accordance with an example of the present disclosure. FIG. 2B illustrates an enlarged side cutout view of an exit of the multipole section-based ion funnel 100, in accordance with an example of the present disclosure. FIG. 3 illustrates an enlarged isometric view of a pair of adjacently disposed members of the multipole section-based ion funnel 100, in accordance with an example of the present disclosure.

Referring to FIG. 1A-3, the multipole section-based ion funnel 100 may include an ion funnel section 102 formed by at least one pair of adjacently disposed members 300-1, 300-2, . . . , 300-n. A first member (e.g., 300-1) of the at least one pair of adjacently disposed members 300-1, 300-2, . . . , 300-n may include a pole structure 302. Further, a second member (e.g., 300-2) of the at least one pair of adjacently disposed members 300-1, 300-2, . . . , 300-n may include a pole structure 304 that is engageable with the pole structure 302 of the first member 300-1 to form a multipole structure 306. The specific example of FIG. 3 may represent an electrode pair that may fit at an entrance, an exit, or any another location of the multipole section-based ion funnel 100. In the example shown, the electrode pair may fit at an exit of the multipole section-based ion funnel 100. Further, the example of FIG. 3 may represent an octopole structure.

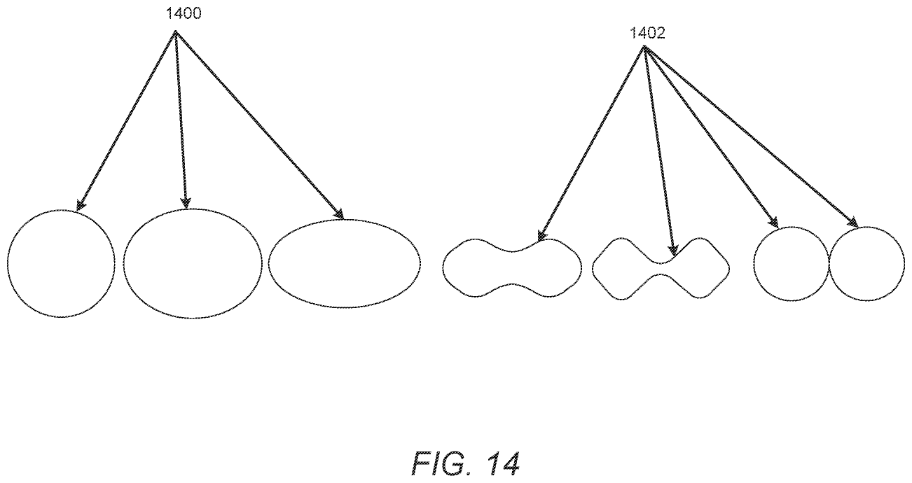

With continued reference to FIGS. 1A-3, the pole structure 302 of the first member 300-1 and the pole structure 304 of the second member 300-2 may form at least two poles. For example, the pole structure 302 of the first member 300-1 and the pole structure 304 of the second member 300-2 may form a quadrupole, a hexapole, etc. As shown in FIG. 3, the at least two poles may be symmetrically disposed along a circumference of a circular opening 308 formed by the at least one pair of adjacently disposed members 300-1, 300-2, . . . , 300-n. Alternatively, the at least two poles may be disposed along a boundary of a non-circular opening (e.g., see FIG. 14 for different examples of openings) formed by the at least one pair of adjacently disposed members 300-1, 300-2, . . . , 300-n.

The ion funnel section 102 formed by the at least one pair of adjacently disposed members 300-1, 300-2, . . . , 300-n may be tapered (e.g., including a cross-sectional diameter that gradually increases or decreases, for example, linearly, along a central axis) or profiled (e.g., including a cross-section of a specified shape, such as parabolic, hyperbolic, etc., along a central axis) to form a reduced diameter exit 104 for ions traversing through the multipole section-based ion funnel 100. For example, the exit 104 may be disposed along a central axis 106 of the multipole section-based ion funnel 100.

According to examples disclosed herein, the multipole structure 306 may permit operation of the multipole section-based ion funnel 100 for a pressure range of approximately 1 mTorr to approximately 10 Torr. For example, based on the implementation of the multipole segments at the exit end of the multipole section-based ion funnel 100, the funnel may be utilized over a relatively wider range of operating pressures. For example, the funnel can be used down to pressures of 1 mTorr. In this regard, the multipole section-based ion funnel 100 may function as a collision cell in a mass spectrometer, collecting and cooling ions from high energies at the entrance, and forming a well-defined exit beam with a relatively small diameter at the exit.

As shown in the specific example of FIGS. 1A-1C and 3, the first member 300-1 and/or the second member 300-2 of the at least one pair of adjacently disposed members 300-1, 300-2, . . . , 300-n may be at least partially formed as a plate. Alternatively, the first member 300-1 and/or the second member 300-2 of the at least one pair of adjacently disposed members 300-1, 300-2, . . . , 300-n may be formed to include other shapes that may include, for example, a curvature in the surface of one or more of the adjacently disposed members.

Referring to FIGS. 1A-1C and 3, when viewed separately from the multipole section-based ion funnel 100, the multipole structure 306 may include a first member 300-1 of a pair of members, with the first member 300-1 including a pole structure 302, and a second member 300-2 of the pair of members. The second member 300-2 may include a pole structure 304 that is engageable with the pole structure 302 of the first member 300-1 to form the multipole structure 306 for a multipole section-based ion funnel 100.

Referring to FIGS. 1A-3, the multipole section-based ion funnel 100 may include the tapered ion funnel section 102 formed by a plurality of pairs of adjacently disposed members 300-1, 300-2, . . . , 300-n. A first member 300-1 of a pair of members of the plurality of pairs of adjacently disposed members 300-1, 300-2, . . . , 300-n may include a pole structure 302. A second member 300-2 of the pair of members of the plurality of pairs of adjacently disposed members may include a pole structure 304 that is engageable with the pole structure 302 of the first member 300-1 to form a multipole structure 306. Further, at least two pairs (e.g., pairs 110 and 112) of the plurality of pairs of the adjacently disposed members 300-1, 300-2, . . . , 300-n may include successively reduced diameter openings (e.g., see FIG. 1A). These reduced diameter openings may form the reduced diameter exit 104.

In one example, a first pair of the plurality of pairs of the adjacently disposed members 300-1, 300-2, . . . , 300-n may include a specified number of poles that is greater than a specified number of poles for a second pair of the plurality of pairs of the adjacently disposed members 300-1, 300-2, . . . , 300-n. For example, the first pair 110 may include eight poles, whereas the second pair 112 may include six poles.

In one example, the second pair of the plurality of pairs of the adjacently disposed members 300-1, 300-2, . . . , 300-n may be disposed closer to the exit 104 of the multipole section-based ion funnel 100 compared to the first pair of the plurality of pairs of the adjacently disposed members. Alternatively, the second pair of the plurality of pairs of the adjacently disposed members 300-1, 300-2, . . . , 300-n may be disposed closer to an entrance 114 of the multipole section-based ion funnel 100 compared to the first pair of the plurality of pairs of the adjacently disposed members. For example, although not shown in FIG. 1A, the plurality of pairs of the adjacently disposed members 300-1, 300-2, . . . , 300-n may be disposed closer to the entrance 114 to form the tapered funnel section towards the entrance 114.

In another example, a first pair of the plurality of pairs of the adjacently disposed members 300-1, 300-2, . . . , 300-n and a second pair of the plurality of pairs of the adjacently disposed members may include an equal number of poles. For example, the first pair 110 and the second pair 112 may each include six poles.

Referring to FIGS. 1A-3, FIG. 3 shows a pair of the adjacently disposed members 300-1 and 300-2. In this regard, instead of two adjacently disposed members 300-1 and 300-2, the adjacently disposed members may include three adjacently disposed members. For example, the three adjacently disposed members may include two external and one central adjacently disposed member. The three adjacently disposed members may form pole structures to form three poles that are 120° apart. In this case, the RF phase may change with a 120° phase shift for the three poles.

Referring to FIGS. 1A-3, FIG. 3 shows a pair of the adjacently disposed members 300-1 and 300-2. In this regard, the adjacently disposed members 300-1 and 300-2 may be formed as a single structure each as shown, or from multiple parts that form each of the adjacently disposed members 300-1 and 300-2.

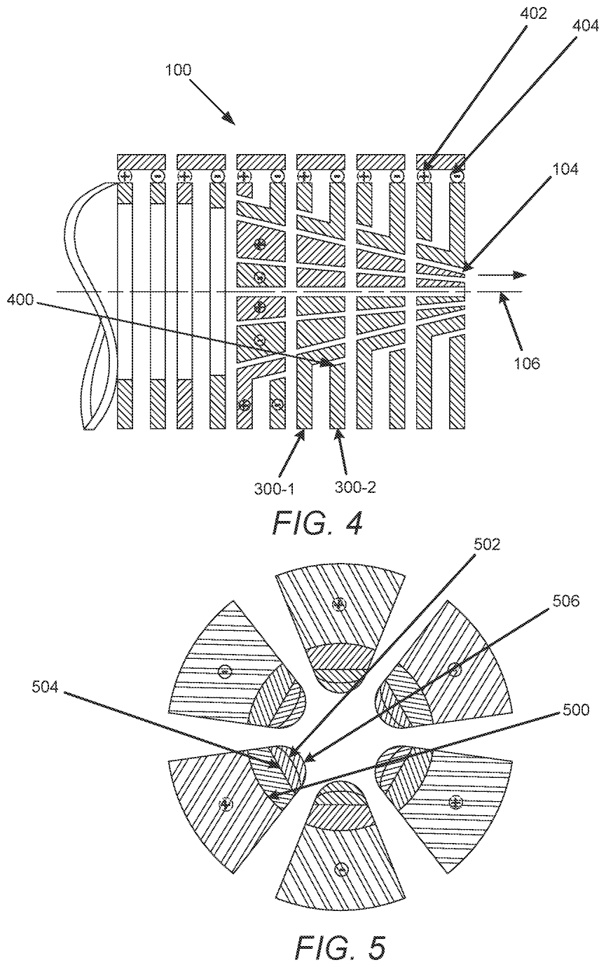

FIG. 4 illustrates an enlarged cutout side view of the exit of the multipole section-based ion funnel 100, in accordance with an example of the present disclosure.

Referring to FIGS. 3 and 4, the pole structure 302 of the first member 300-1 and/or the pole structure 304 of the second member 300-2 may be transverse (e.g., at 400) relative to the central axis 106 of the multipole section-based ion funnel 100. Accordingly, although not shown in FIG. 4, one of the pole structures 302 or 304 may be transverse, while the other pole structure is flat (e.g., parallel) relative to the central axis 106. In other examples, both pole structures 302 and 304 may be transverse relative to the central axis 106 as shown in FIG. 4.

The at least one pair of adjacently disposed members 300-1, 300-2, . . . , 300-n may form an electrode pair that may include at least two poles 402 and 404 of opposite polarities. For example, pole 402 may include a positive polarity, whereas pole 404 may include a negative polarity (and vice-versa).

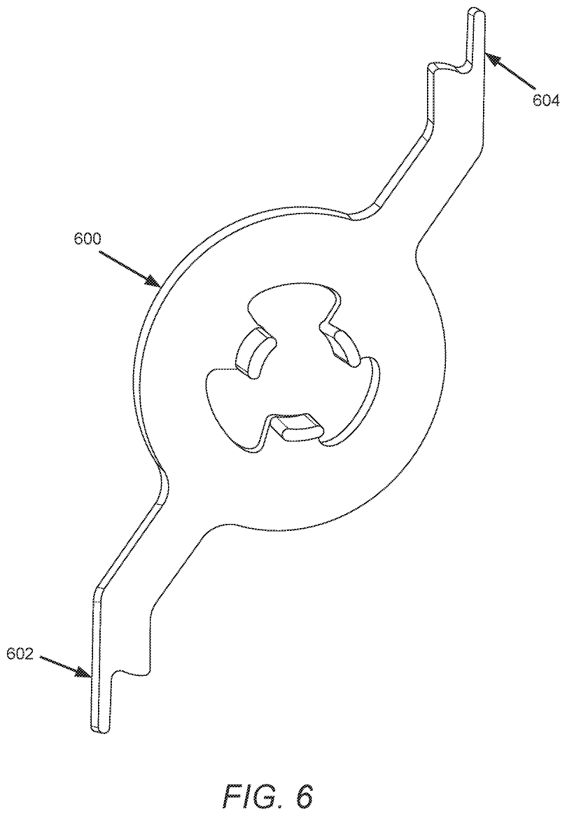

FIG. 5 illustrates an enlarged cutout front view of the exit of FIG. 4, viewing the exit from inside of the multipole section-based ion funnel 100, illustrating various examples of pole structures, in accordance with an example of the present disclosure.

With reference to FIGS. 1A-1C, 3, 4, and 5, the pole structure 302 of the first member 300-1 and/or the pole structure 304 of the second member 300-2 may include a concave profile 500, a convex profile 502, a generally flat profile 504, or a round profile 506. The tapering of the pole structures, for example, from concave to flat to convex may provide a smooth transition of an RF field from a two lens dipole to a multipole lens pair (e.g., the adjacently disposed members) based on the change from a circular to a round or hyperbolic shape. In the example of FIG. 5, the concave profile 500 may provide a 4.5 mm distance from the central axis 106, the convex profile 502 may provide a 3.5 mm distance from the central axis 106, the flat profile 504 may provide a 4.0 mm distance from the central axis 106, and the round profile 506 may provide a 3.0 distance from the central axis 106, to thus provide a smooth transition.

For the tapered ion funnel section 102, the tapering may be facilitated by a multipole and electrode pair shape in a radial direction with transitioning from concave to flat to convex, and by the tapering angle of each pair of adjacently disposed members (e.g., electrode pair) in the direction of the exit 104. Alternatively, the tapering may transition from convex to flat to concave, or any combination of these three (or other) types of profiles.

FIG. 6 illustrates an enlarged isometric view of another example of a member of the multipole section-based ion funnel 100, in accordance with an example of the present disclosure.

Referring to FIGS. 3 and 6, compared to the example of the first member 300-1 and the second member 300-2, member 600 may include electrode ends 602 and 604 shaped as shown for electrical interconnection to a circuit board that mounts the other members. Thus, in a similar manner as shown in FIGS. 3 and 6, the members of the multipole section-based ion funnel 100 may include different types of configurations for electrical interconnection.

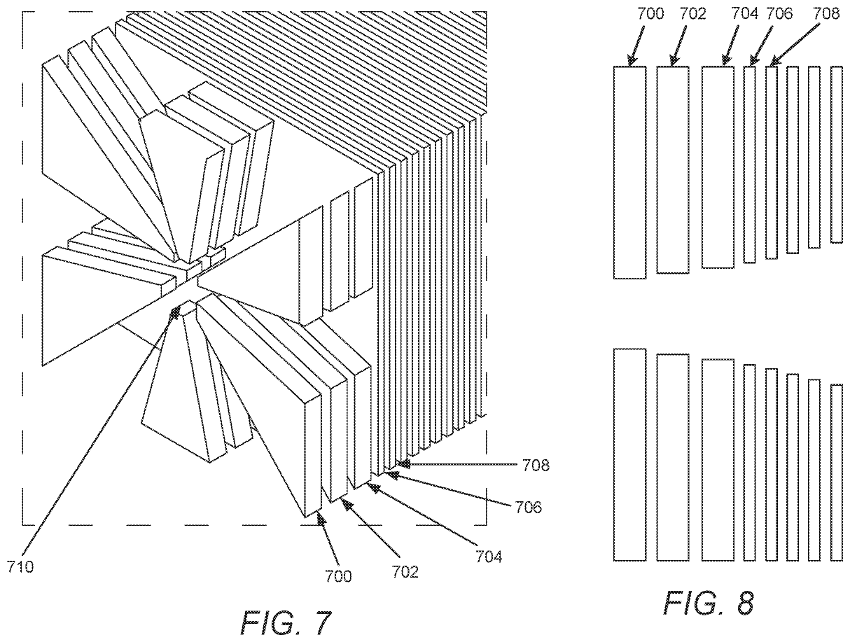

FIG. 7 illustrates an enlarged isometric diagrammatic view of a hexagonal layout of pole structures, in accordance with an example of the present disclosure. FIG. 8 illustrates an enlarged side diagrammatic view of the hexagonal layout of the pole structures of FIG. 7, in accordance with an example of the present disclosure.

Referring to FIGS. 7 and 8, the adjacently disposed members (e.g., pairs shown at 700, 702, 704, etc.) may be stacked in a similar manner as flat funnel plates 706, 708, etc., are stacked so that several pairs of the adjacently disposed members may be used to extend the funnel exit decrease in diameter. The example of FIGS. 7 and 8 shows three stacked hexapole pairs of adjacently disposed members 700, 702, and 704. Moreover, the associated pole structures may be flat as shown at 710.

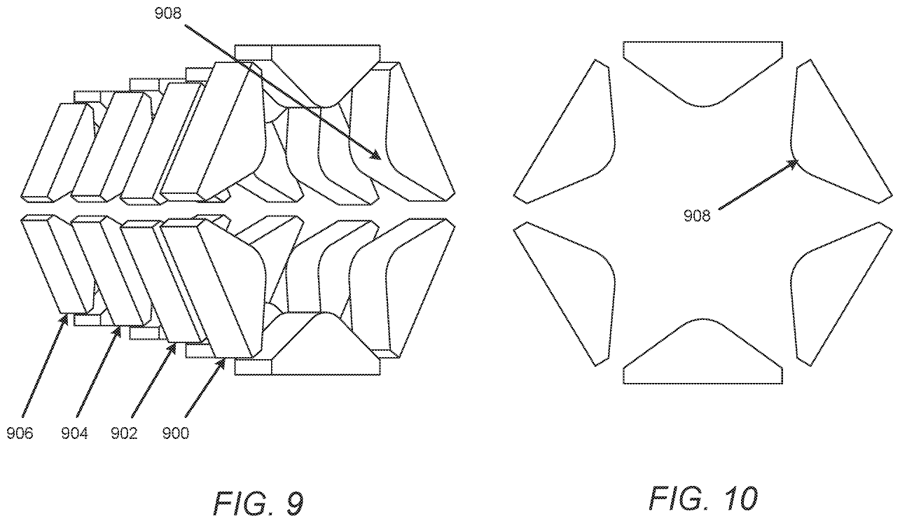

FIG. 9 illustrates an enlarged isometric diagrammatic view of another hexagonal layout of pole structures, in accordance with an example of the present disclosure. FIG. 10 illustrates an enlarged side diagrammatic view of the hexagonal layout of the pole structures of FIG. 9, in accordance with an example of the present disclosure.

Referring to FIGS. 9 and 10, in a similar manner as the adjacently disposed members of FIGS. 7 and 8, the adjacently disposed members (e.g., pairs shown at 900, 902, 904, 906, etc.) may be stacked to extend the funnel exit decrease in diameter. The example of FIGS. 8 and 9 shows four stacked hexapole pairs of adjacently disposed members 900, 902, 904, and 906. Moreover, the associated pole structures may be convex as shown at 908. In this regard, the hexapole pole structures may approximate a hyperbolic shape.

With respect to the examples of FIGS. 7-10, in some examples, higher order pole structures may be utilized for relatively large internal diameters of the ion funnel. For example, for relatively large internal diameters, octopole, 10-pole or higher order pairs of adjacently disposed members may be utilized, whereas for relatively small internal diameters of the ion funnel, the entrance, and/or the exit of the ion funnel, lower order pairs of adjacently disposed members may be utilized. In some examples, combined ion funnel designs may start with a 10-pole followed by octopole, hexapole, etc., as needed to reduce the exit diameter.

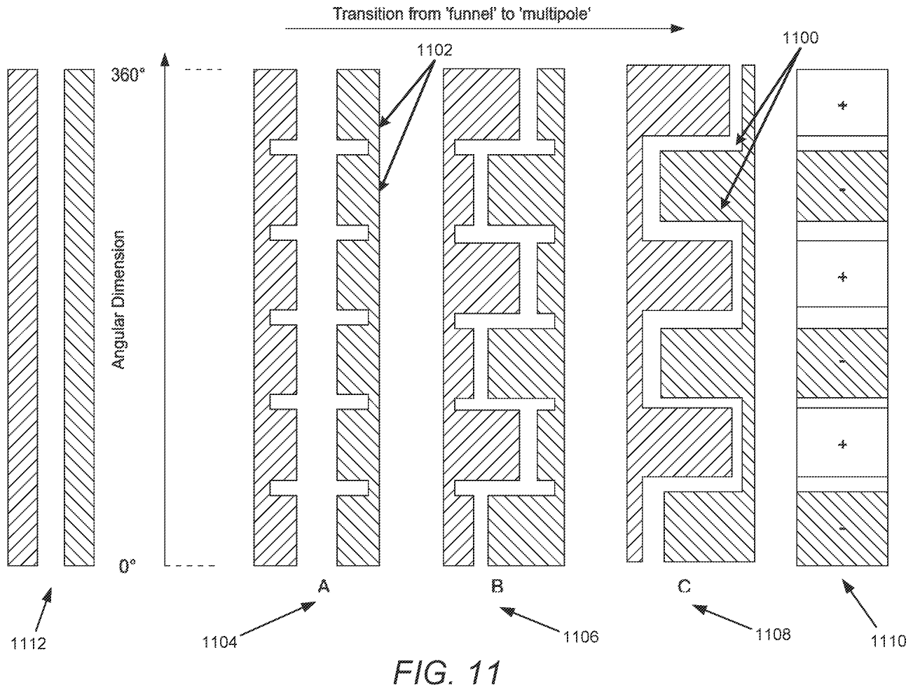

FIG. 11 illustrates RF field distribution for different types of configurations of the multipole section-based ion funnel 100, in accordance with an example of the present disclosure.

With reference to FIGS. 1A-1C, 3, and 11, as disclosed herein, the pole structure 302 of the first member 300-1 and the pole structure 304 of the second member 300-2 may form at least two poles. As shown in FIG. 1A, the multipole section-based ion funnel may include an ion funnel transition section 116 formed by at least one generally flat plate 118 including a first opening 120, and the at least one pair of adjacently disposed members including a second opening 122 that is disposed along a same axis (e.g., the central axis 106) as the first opening. As shown in FIGS. 1A-1C, 3, and 11, RF field distribution areas 1100 at the at least two poles may be greater than RF field distribution areas 1102 at another ion funnel section (e.g., at 108) of the multipole section-based ion funnel 100 that does not include the at least one pair of adjacently disposed members 300-1, 300-2, . . . , 300-n. In this regard, FIG. 11 shows a transition from ‘funnel’ to ‘multipole’ from 1102 to 1110. Specifically, at 1104, the RF field distribution of ion funnel section 108 is shown, with an adjacently disposed lens pair at 1112. At 1106, a mix field distribution for an ion funnel and a pair of adjacently disposed members 300-1, 300-2, . . . , 300-n that includes a hexapole configuration is shown. At 1108, a field distribution for a pair of adjacently disposed members 300-1, 300-2, . . . , 300-n that includes a hexapole configuration is shown, transitioning to an exit field distribution at 1110.

The plots of FIG. 11 illustrate possible inside surfaces of the at least one pair of adjacently disposed members 300-1, 300-2, . . . , 300-n plotted with the angle around the central axis 106 in the vertical axis versus the axial distance along the central axis 106 on the horizontal axis. The transitional elements may be created to include aspects of fields from both a flat plate and a pair of the adjacently disposed members 300-1, 300-2, . . . , 300-n (e.g., multipole sections), and thus may assist in the transition from one form to the other. This transition may be adjusted to maintain the effective pseudopotential created at the funnel wall so that ions are contained within the space with no weak points.

With reference to FIGS. 3, 4, and 11, as disclosed herein, a first pair of the plurality of pairs of the adjacently disposed members 300-1, 300-2, . . . , 300-n and a second pair of the plurality of pairs of the adjacently disposed members may include an equal number of poles. For example, the first pair 110 and the second pair 112 may each include six poles. In this regard, an additional clamp may be used for the transition of the first and second members from plate (dipole) to 1104-1108 (e.g., see FIG. 11), progressing to 402-404 (e.g., see FIG. 4), progressing to 500-502 (e.g., see FIG. 5), and further progressing to essentially round. This type of a layout may create a controlled transition from a dipole field to a quadrupole, hexapole, octopole, etc., field.

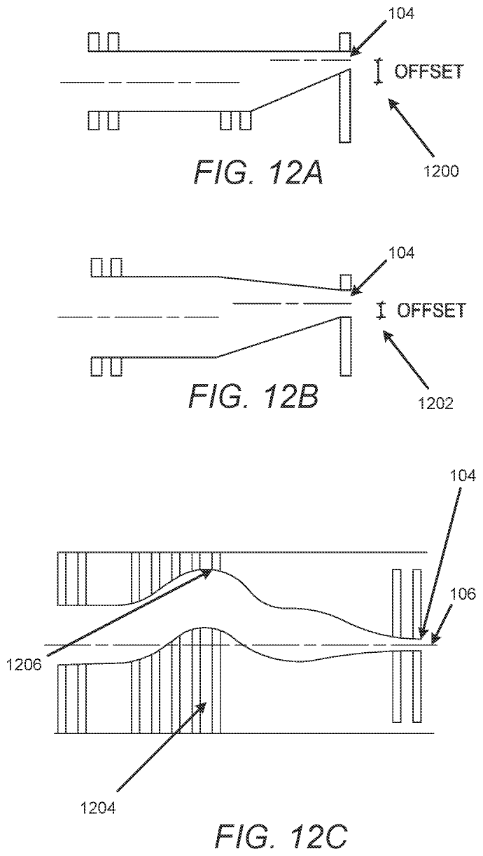

FIGS. 12A, 12B, and 12C illustrate different types of exits and flight paths for ions in the multipole section-based ion funnel 100, in accordance with an example of the present disclosure.

With reference to FIGS. 1A-1C, 3, and 12A-12C, the ion funnel section 102 formed by the at least one pair of adjacently disposed members 300-1, 300-2, . . . , 300-n may be tapered or profiled to form a reduced diameter exit 104 for ions traversing through the multipole section-based ion funnel 100. For example, the exit 104 may be disposed along the central axis 106 of the multipole section-based ion funnel 100. Alternatively, the exit 104 may be radially offset as shown at 1200 of FIG. 12A and 1202 of FIG. 12B relative to the central axis 106 of the multipole section-based ion funnel 100.

Referring to FIG. 12C, the ion funnel section 102 may include a plurality of further members 1204. Each member of the plurality of further members 1204 may include an opening 1206 that is offset from the central axis 106 of the multipole section-based ion funnel 100. Further, the plurality of further members 1204 may form a non-direct flight path for ions traversing through the multipole section-based ion funnel 100. The example of FIG. 12C thus illustrates an indirect ion flight path while being axially centered on pre and post alignment ion optical elements.

Therefore, with reference to FIGS. 12A-12C, with respect to the at least one pair of adjacently disposed members 300-1, 300-2, . . . , 300-n, non-direct ion flight paths may be implemented to prevent neutrals and contaminants from driving further into the detecting section of an associated quadrupole time-of-flight (QTOF) instrument.

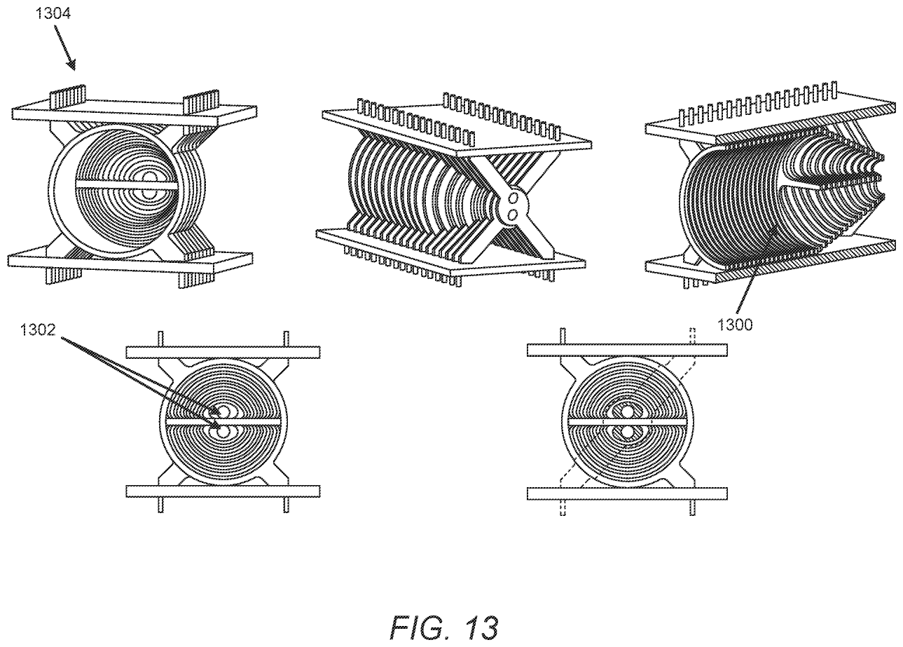

FIG. 13 illustrates various views of a multipole section-based ion funnel including a plurality of exits, in accordance with an example of the present disclosure.

Referring to FIG. 13, the ion funnel section 1300 formed by the at least one pair of adjacently disposed members 300-1, 300-2, . . . , 300-n may be tapered or profiled to form a plurality of reduced diameter exits 1302 for ions traversing through the multipole section-based ion funnel 1304. For example, the ion funnel section 1300 is shown as including two exits 1302, but may include greater than two exits.

FIG. 14 illustrates examples of exit or internal configurations for the multipole section-based ion funnel 100, in accordance with an example of the present disclosure.

Referring to FIG. 14, as shown at 1400, various options for internal cross-sections of the multipole section-based ion funnel 100 for a single entrance or exit are shown. At 1402, various options for internal cross-sections of the multipole section-based ion funnel 100 for a plurality of entrances or exits are shown. The examples at 1400 and 1402 may include flat plates, a mixture of flat plates and one or more pairs of the adjacently disposed members 300-1, 300-2, . . . , 300-n, or just the one or more pairs of the adjacently disposed members 300-1, 300-2, . . . , 300-n.

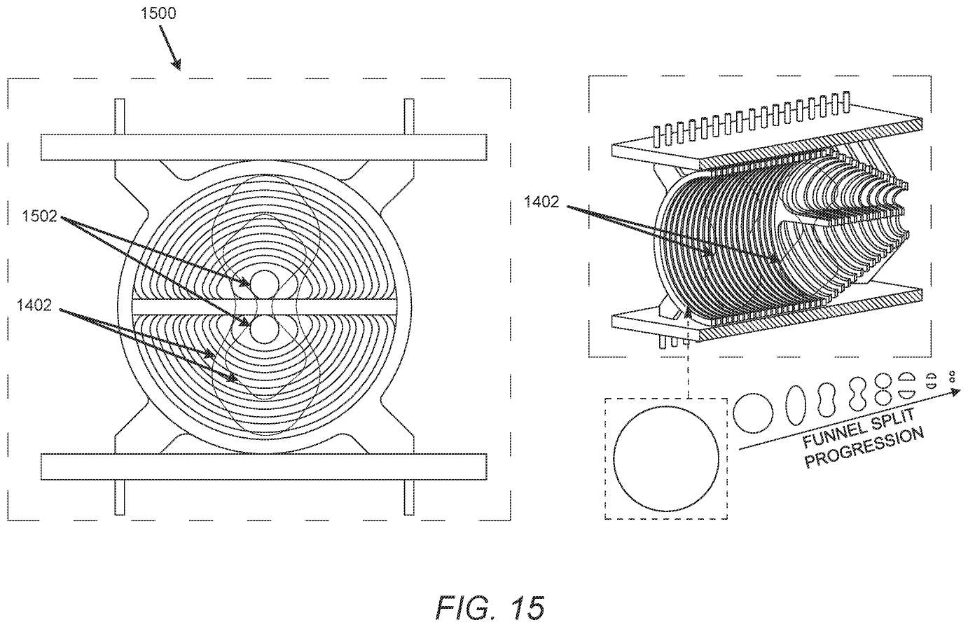

FIG. 15 illustrates examples of implementation of the internal configurations of FIG. 14 for the multipole section-based ion funnel 100, in accordance with an example of the present disclosure.

Referring to FIG. 15, examples of internal cross-sections 1402 are shown superimposed on a multipole section-based ion funnel 1500. Exits 1502 are shown with their centers dividing the dual exit funnel.

Referring to FIGS. 1A-1C, 2A-2B, 12A-12C, and 15, the funnel design of the multipole section-based ion funnel 100 may include the conical (e.g., funnel) shape as shown. Alternatively, the funnel design may include a variety of other internal shapes, entrance shapes, and exit shapes. In this regard, the entrance(s), exit(s), and internal areas of the multipole section-based ion funnel 100 may be tapered (e.g., reversed tapered for the entrance compared to the exit), or include a constant diameter. The entrance(s), exit(s), and internal areas of the multipole section-based ion funnel 100 may also be circular, or include different configurations as discussed above with reference to FIG. 14. For example, if the internal area of the multipole section-based ion funnel 100 is implemented to include a flattened circumference, the exit ion beam may include a relatively small height and a relatively larger width.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims -and their equivalents- in which all terms are meant in their broadest reasonable sense unless otherwise indicated.

What is claimed is:

1. A multipole section-based ion funnel comprising:
an ion funnel section formed by at least one pair of adjacently disposed members,
wherein a first member of the at least one pair of adjacently disposed members includes a pole structure, and
wherein a second member of the at least one pair of adjacently disposed members includes a pole structure that is engageable with the pole structure of the first member to form a multipole structure.

2. The multipole section-based ion funnel according to claim 1, wherein the pole structure of the first member and the pole structure of the second member form at least two poles.

3. The multipole section-based ion funnel according to claim 2, wherein the at least two poles are symmetrically disposed along a circumference of a circular opening formed by the at least one pair of adjacently disposed members.

4. The multipole section-based ion funnel according to claim 2, wherein the at least two poles are disposed along a boundary of a non-circular opening formed by the at least one pair of adjacently disposed members.

5. The multipole section-based ion funnel according to claim 2, wherein radio frequency (RF) field distribution areas at the at least two poles are greater than RF field distribution areas at another ion funnel section of the multipole section-based ion funnel that does not include the at least one pair of adjacently disposed members.

6. The multipole section-based ion funnel according to claim 1, wherein at least one of the pole structure of the first member or the pole structure of the second member includes at least one of a concave, a convex, a generally flat, or a round profile.

7. The multipole section-based ion funnel according to claim 1, wherein the at least one pair of adjacently disposed members forms an electrode pair that includes at least two poles of opposite polarities.

8. The multipole section-based ion funnel according to claim 1, wherein the ion funnel section formed by the at least one pair of adjacently disposed members is tapered or profiled to form a reduced diameter exit for ions traversing through the multipole section-based ion funnel.

9. The multipole section-based ion funnel according to claim 8, wherein the exit is disposed along a central axis of the multipole section-based ion funnel.

10. The multipole section-based ion funnel according to claim 9, wherein the exit is radially offset relative to a central axis of the multipole section-based ion funnel.

11. The multipole section-based ion funnel according to claim 1, wherein the ion funnel section formed by the at least one pair of adjacently disposed members includes a linear funnel progression from a dipole structure to the multipole structure that includes greater than two poles.

12. The multipole section-based ion funnel according to claim 1, wherein the ion funnel section formed by the at least one pair of adjacently disposed members is tapered or profiled to form a plurality of reduced diameter exits for ions traversing through the multipole section-based ion funnel.

13. The multipole section-based ion funnel according to claim 1, wherein the ion funnel section includes a plurality of further members, wherein each member of the plurality of further members includes an opening that is offset from a central axis of the multipole section-based ion funnel, and wherein the plurality of further members forms a non-direct flight path for ions traversing through the multipole section-based ion funnel.

14. The multipole section-based ion funnel according to claim 1, wherein the multipole structure permits operation of the multipole section-based ion funnel for a pressure range of approximately 1 mTorr to approximately 10 Torr.

15. The multipole section-based ion funnel according to claim 1, wherein at least one of the first member or the second member of the at least one pair of adjacently disposed members is at least partially formed as a plate.

16. The multipole section-based ion funnel according to claim 1, further comprising:
an ion funnel transition section formed by:
at least one generally flat plate including a first opening; and
the at least one pair of adjacently disposed members including a second opening that is disposed along a same axis as the first opening.

17. A multipole structure comprising:
a first member of a pair of members, wherein the first member includes a pole structure; and
a second member of the pair of members, wherein the second member includes a pole structure that is engageable with the pole structure of the first member to form the multipole structure for a multipole section-based ion funnel.

18. The multipole structure according to claim 17, wherein at least one of the pole structure of the first member or the pole structure of the second member is transverse relative to a central axis of the multipole section-based ion funnel.

19. A multipole section-based ion funnel comprising:
a tapered ion funnel section formed by a plurality of pairs of adjacently disposed members,
wherein a first member of a pair of members of the plurality of pairs of adjacently disposed members includes a pole structure,
wherein a second member of the pair of members of the plurality of pairs of adjacently disposed members includes a pole structure that is engageable with the pole structure of the first member to form a multipole structure, and
wherein at least two pairs of the plurality of pairs of the adjacently disposed members include successively reduced diameter openings.

20. The multipole section-based ion funnel according to claim 19, wherein a first pair of the plurality of pairs of the adjacently disposed members includes a specified number of poles that is greater than a specified number of poles for a second pair of the plurality of pairs of the adjacently disposed members.
